(19) United States
(12) Patent Application Publication
(10) Pub. No.: US 2005/0013542 A1
(43) Pub. Date: Jan. 20, 2005

(54) Coupler having reduction of reflections to light source

(75) Inventors: Raymond W. Blasingame, Richardson, TX (US); Bo Su Chen, Plano, TX (US); James K. Guenter, Garland, TX (US); James C. Lee, Plymouth, MN (US); Bernard Q. Li, Plymouth, MN (US); James D Orenstein, Duncanville, TX (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(73) Assignee: Honeywell International Inc.

(21) Appl. No.: 10/620,512

(22) Filed: Jul. 16, 2003

(51) Int. Cl. G02B 6/26; G02B 6/32

(52) U.S. Cl. 385/38; 385/33

(57) ABSTRACT

A coupler for coupling light between an optoelectronic element and an optical fiber. The coupler has a fiber stop that is made of a material that has an index of refraction that effectively matches the index of refraction of the optical fiber being coupled to the optoelectronic element. The fiber stop may be flat or rounded. It may be a discrete or molded part of the coupler assembly. The end of the fiber being stopped may be flat or rounded.

### BACKGROUND

The present invention relates to devices for connecting light sources or other devices to optical fibers, and particularly it relates to efficient coupling of light signals to and from optical fibers and the devices capable of effecting such coupling. More particularly, the invention relates to a coupling element made of an optically transmissive material disposed in the housing between the end of the optical fiber and the optoelectronic element in order to reduce back-reflections.

Several patent documents may be related to optical coupling between optoelectronic elements and optical media. They include U.S. Pat. No. 6,086,263 by Selli et al., issued Jul. 11, 2000, entitled “Active Device Receptacle” and owned by the assignee of the present application; U.S. Pat. No. 6,302,596 B1 by Cohen et al., issued Oct. 16, 2001, and entitled “Small Form Factor Optoelectronic Receivers”; U.S. Pat. No. 5,692,083 by Bennet, issued Nov. 25, 1997, and entitled “In-Line Unitary Optical Device Mount and Package therefore”; and U.S. Pat. No. 6,536,959 B2, by Kuhn et al., issued Mar. 25, 2003, and entitled “Coupling Configuration for Connecting an Optical Fiber to an Optoelectronic Component”; which are herein incorporated by reference.

In the context of the invention, the optoelectronic element may be understood as being a transmitter or a receiver. When electrically driven, the optoelectronic element in the form of a transmitter converts the electrical signals into optical signals that are transmitted in the form of light signals. On receiving optical signals, the optoelectronic element in the form of a receiver converts these signals into corresponding electrical signals that can be tapped off at the output. In addition, an optical fiber is understood to be any apparatus for forwarding an optical signal with spatial limitation, in particular preformed optical fibers and so-called waveguides.

For optical data transmission at a high bit rate between an optoelectronic transmitter and an optoelectronic receiver, it is essential that back-reflections to the optoelectronic transmitter do not exceed a particular limit value defined in standards, in order to ensure fault-free operation of the optoelectronic transmitter. For instance, when coupling an optoelectronic element such as a vertical cavity surface emitting element (VCSEL) or other laser types of light sources to an optical fiber, the light reflected from the face of the fiber can be reintroduced to the cavity of the laser source. This undesirable reflection may cause fluctuation in the coupled optical energy from the source.

### SUMMARY

The invention provides for coupling light between an optoelectronic element and an optical medium. The medium stop of a coupler may have an index of refraction that matches the index of the medium.

### BRIEF DESCRIPTION OF THE DRAWING

FIG. 1 shows a cross section of an optoelectronic element and fiber coupler;

FIG. 1a is a detailed view of a weld for securing a sleeve after adjustment of the optoelectronic element relative to a coupler lens.

FIG. 2 shows a barrel of the coupler;

FIGS. 3a and 3b are perspective view of the coupler;

FIG. 4 is a cross section of the coupler showing a fiber stop;

FIG. 5 is a cross section of a coupler with a molded lens and fiber stop;

FIG. 5a is the same as FIG. 5 except that the optical fiber has a rounded end at the fiber stop;

FIG. 6 shows a coupler having a molded lens which acts as the fiber stop;

FIG. 6a is similar to FIG. 6 except the fiber has a rounded end at the fiber stop;

FIG. 7 shows a coupler having a ball lens as a fiber stop; and

FIG. 7a is the same as FIG. 7 except the fiber has a rounded end at the fiber stop.

### DESCRIPTION

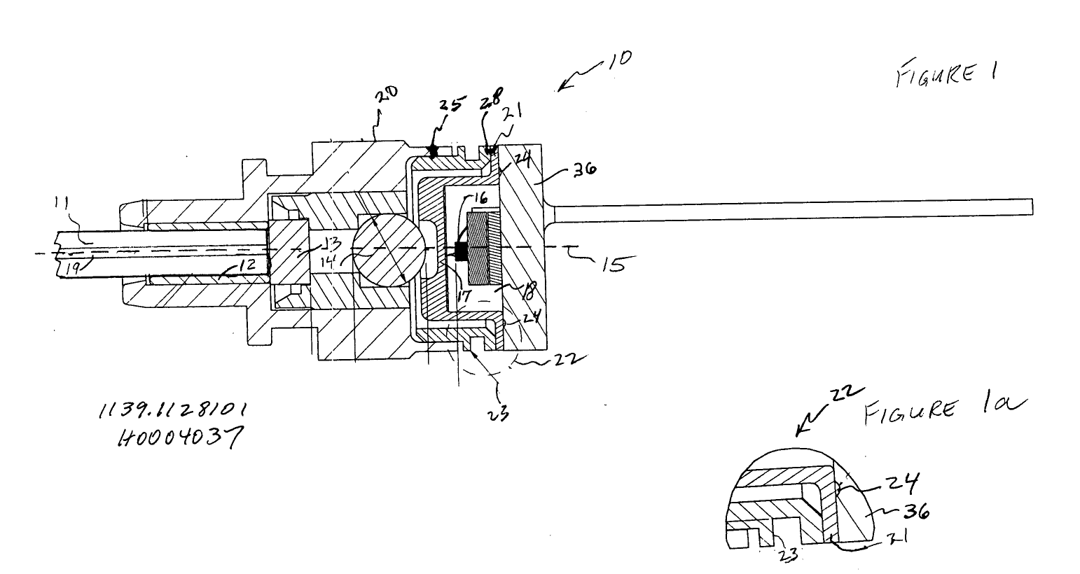

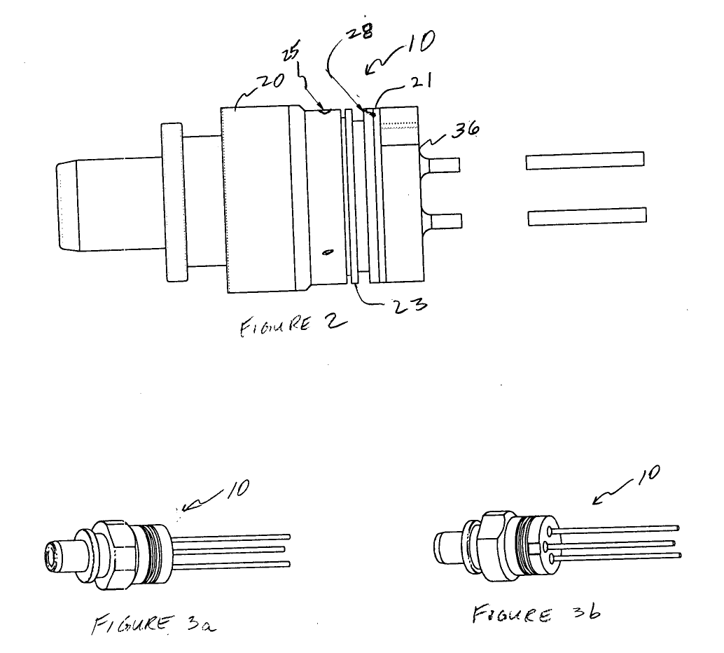

FIG. 1 shows a cross section of a coupler 10. An optical medium 11 (e.g., an optical fiber) may be inserted into a solid zirconia sleeve 12 that fits around fiber 11. Window 13 may be a fiber stop for fiber 11 which is in contact with the window. The index of refraction of window 13 may match the index of fiber 11. Window 13 may be composed of silica, borofloat, glass, plastic or other material having an index of refraction matching the index of fiber 11 core 19. A ball lens 14 may be situated along an optical axis 15. Also, along axis 15 may be an optoelectronic element 16. Optoelectronic element 16 may be a laser light source such as a VCSEL. On the other hand, element 16 may be a detector.

Ball lens 14 comprised of LASFN-9 material, glass, plastic or any other appropriate material. Also, along this axis is a window 17 that is part of a sealed package 18 that houses element 16. Window 17 may consist of BK-7, borofloat or other appropriate material. Window 13 and ball lens 14 may be enclosed in a housing regarded as an LC barrel 20. A TO-56 (or TO) can 21 and header 36 enclosing optoelectronic element 16 may have can 21 fitted into one end of barrel 20. At the other end of the barrel 20 may be zirconia sleeve 12 into which optical fiber 11 may be situated or inserted. Barrel 20 may be fabricated from one of various metals or plastics.

FIG. 1a is a detailed portion 22 of FIG. 1. It shows the weld projection (i.e., the weld ring) 24 of can 21 to header 36. A z-direction (in the direction of axis 15) adjustment involves a z-alignment sleeve 23 that may adjustably slide in a that direction within an inset bore of barrel 20 so as to adjust the distance of optoelectronic component 16 relative to ball lens 14.

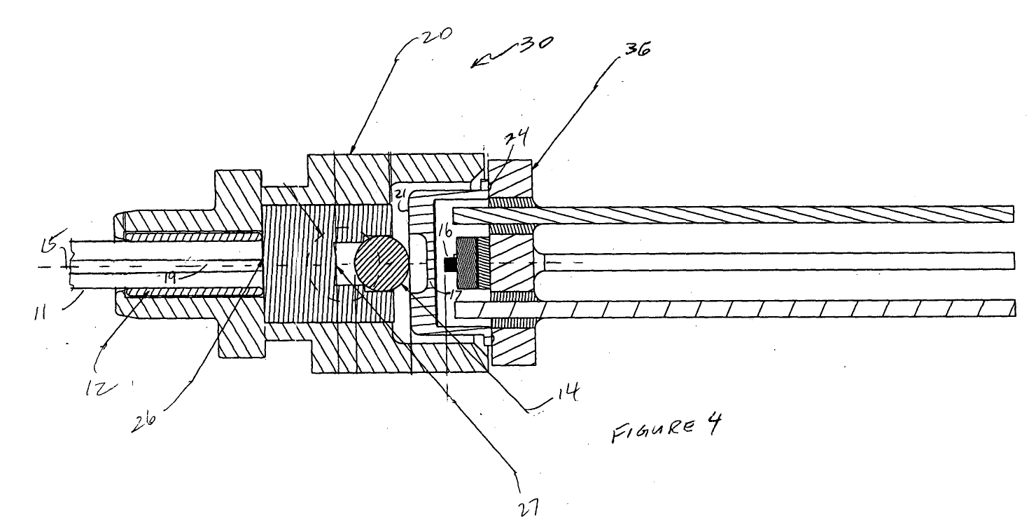

FIG. 2 shows barrel 20 of coupler 10 from an exterior structure perspective. Structure 23 holding can 21 may be moved in a z direction so as to adjust optoelectronic element 16 relative to ball lens 14, window 13 and the end face of core 19 of fiber 11 along axis 15. To secure the z-direction alignment, a z-axis weld 25 (three welds with a 120 degree radial separation) may be implemented. The weld angle may be, but not necessarily, about 45 degrees relative to optical axis 15 as shown by a laser weld 25 through barrel 20 to structure 23. The optical alignment of optoelectronic element 16 relative to ball lens 14, window 13 and the end face of core 19 of fiber 11 along axis 15 in the z-direction may be performed and welds 25 may be applied prior to alignment in the x- and y-directions. The z-axis 15 welds 25 may be performed to join the z-sleeve 23 to connector barrel 20. Welds 25 may be made by welding through the barrel 20 wall into the z-sleeve 23 (like spot welding). The three laser welds 25 may be performed simultaneously.

Weld 24 refers to the window can 21 to TO-56 (or other) header 36 connection. This weld is a 360° weld that forms a hermetic seal between the window can 21 and the TO-56 (or other) header 36. Additionally, in the coupler 10 assembly, there may be two sets of alignment laser welds—welds 25 through the barrel 20 and into the z-alignment sleeve 23 and the other welds 28 for x-y alignment between sleeve 23 and the TO-56 window can 21 which is attached to TO-56 (or other type) header 36.

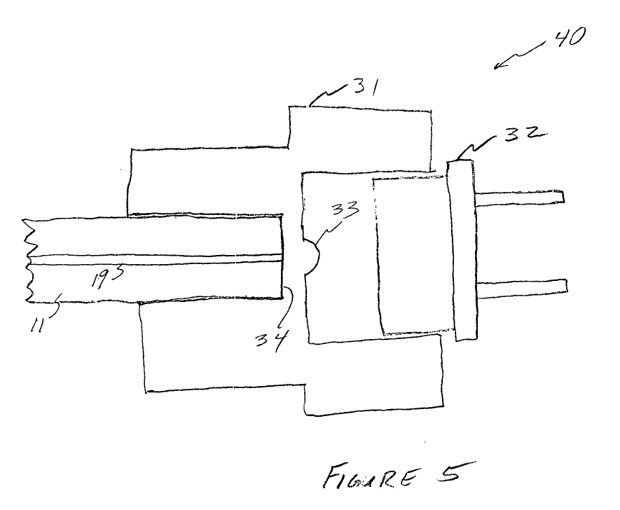

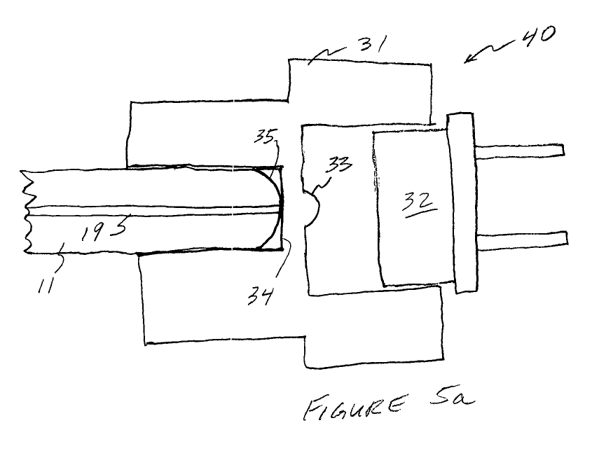

Also, the x and y optical alignments may be performed to obtain maximum coupling. Then three x and y axis alignment welds 28 may be made at 120 degree radial spacing. The weld angle may be, but not necessarily, at about 45 degrees relative to optical axis 15. Welds 28 may join sleeve 23 to the window can 21 flange. These three welds may be made simultaneously. Additionally, it may be necessary to rotate the part after x/y welds 28 are performed to apply additional welds 28 to improve weld torque strength. The welding scheme used for coupler 10 may be applied to other kinds of couplers. FIG. 3 shows a perspective view of coupler 10.

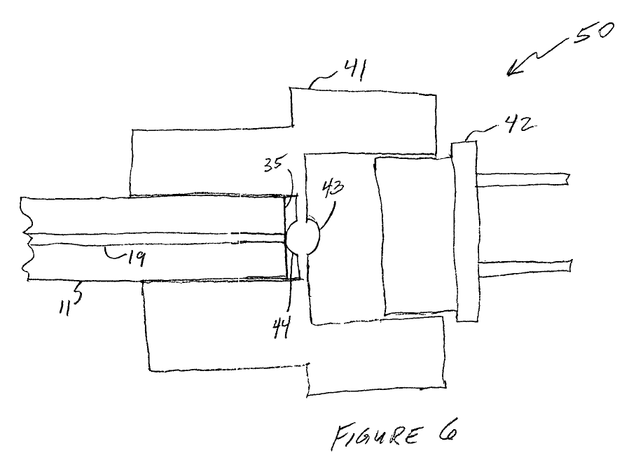

FIG. 4 reveals a coupler 30 having a fiber stop or structure 26. Aspheric lens 27 may be a part of structure 26. Structure 26 supports ball lens 14. Fiber 11 may be inserted within sleeve 12 and against fiber stop 26. The material of structure 26 may have an index of refraction that matches or is approximately the same as the index of refraction of core 19 in fiber 11. Ball lens 14 may likewise be made from a material (e.g., glass) having a suitable index of refraction which may or may not match or be similar to the index of refraction of fiber 11 core 19 (however, it is not necessary here to have index matching) and/or of structure 26 including aspheric lens 27. The aspheric lens 27 and fiber stop structure 26 may be made from LASFN-9, BK7, silica or any other plastic, glass or like material that has an index of refraction that matches or nearly matches the index of refraction of optical fiber core 19. By coupling light into optical fiber 11 through an index matching medium that acts as a fiber stop 26, the amount of light reflected from the face of fiber 11 may be significantly reduced or even eliminated. This index matching medium may be a flat surface such as a silica window 13 (generally flat on two sides), a fiber stop structure 26, or part of a molded lens which may be an aspheric lens 27.

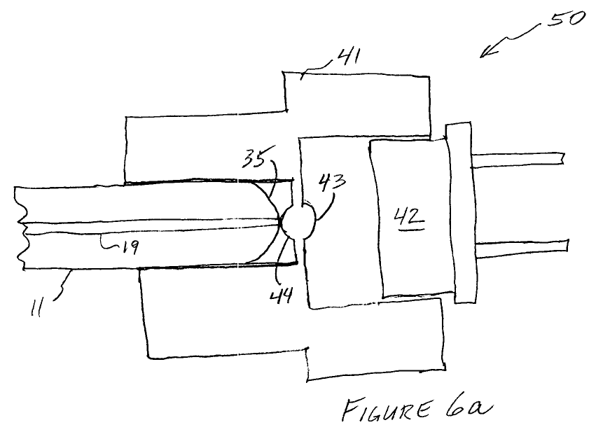

FIG. 5 reveals a coupler 40 having a molded lens 33 and fiber stop 34 situated in a coupler structure 31. Lens 33 may be aspherical or spherical. Optoelectronic component 32 may be a laser light source such as a VCSEL; or it may be a detector. The end of fiber 11 is flat (or has a large radius) and is in contact with the fiber stop 34 surface. The index of refraction of the molded lens 33 and fiber stop 34 may be the same as or similar to the index of refraction of core 19 to reduce or eliminate reflections of light propagating through coupler 40. The end 35 of fiber 11 in coupler 40 may instead be curved as shown in FIG. 5a.

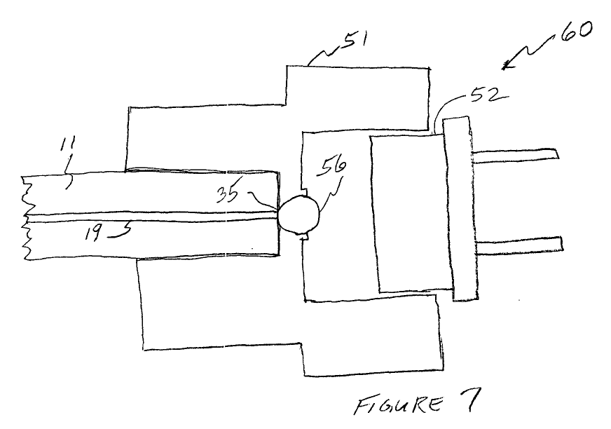

FIG. 6 shows a coupler 50 having a molded lens 43 and a curved fiber stop 44 which is in contact with the fiber 11 core 19 end. Lens 43 may be aspherical or spherical. Optoelectronic component 42 may be a light source or detector. Fiber stop 44 may have lens characteristics of an aspherical or spherical nature. Stop 44 and lens 43 may be molded as an integral part of coupler structure 41. Lens 43 and stop 44 may have an index of refraction which matches or is approximately the same as the index of refraction of core 19 of fiber 11. The end 35 of fiber 11 in coupler 50 may instead be curved as shown in FIG. 6a.

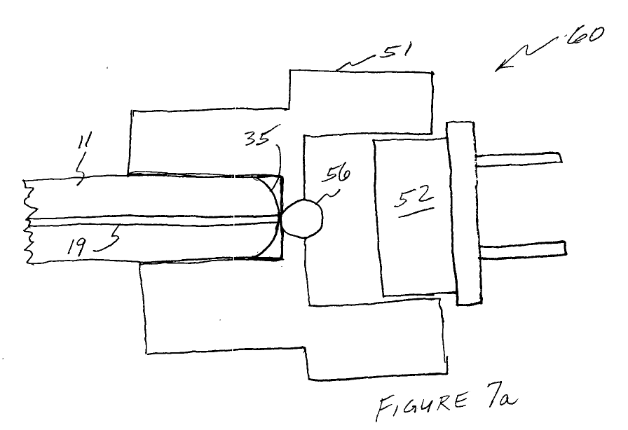

FIG. 7 illustrates a coupler 60 having a ball lens 56 that may be in contact with fiber 11 end 35 at core 19 face. The ball lens 56 may be spherical in shape and situated in a center of barrel 51. Ball lens 56 may be composed of a material that has an index of refraction that matches or is the same as the index of optical fiber core 19. The material may be glass, plastic or other material having the appropriate index of refraction that coincides with the index of fiber 11. The end 35 of fiber 11 in coupler 60 may instead be curved as shown in FIG. 7a. Coupler 60 may incorporate an optoelectronic component 52 which may be a light source or detector

In each of the above figures, each coupler may have a plurality of optoelectronic elements, lens and fiber inserts.

Although the invention has been described with respect to at least one illustrative embodiment, many variations and modifications will become apparent to those skilled in the art upon reading the present specification. It is therefore the intention that the appended claims be interpreted as broadly as possible in view of the prior art to include all such variations and modifications.

1. A coupler comprising:
an optical fiber receiving structure; and
a fiber stop attached to said receiving structure; and
wherein said fiber stop has an index of refraction approximately the same as the index of refraction of a core of said optical fiber.

2. The coupler of claim 1, wherein said fiber stop is a window.

3. The coupler of claim 2, wherein the window comprises a glass material.

4. The coupler of claim 2, wherein the window comprises a plastic material.

5. The coupler of claim 1, wherein said fiber stop is a lens.

6. The coupler of claim 5, wherein the lens comprises a glass material.

7. The coupler of claim 5, wherein the lens comprises a plastic material.

8. The coupler of claim 5, wherein the lens is an aspherical lens.

9. The coupler of claim 5, wherein the lens is a spherical lens.

10. A means for coupling comprising:
means for receiving an optical fiber;
means for stopping a received optical fiber, attached to said means for receiving an optical fiber; and
wherein said means for stopping a received optical fiber has an index of refraction approximately equal to an index of refraction of the received optical fiber.

11. The coupler of claim 10, wherein said means for stopping is a window.

12. The coupler of claim 11, wherein the window comprises a glass material.

13. The coupler of claim 11, wherein the window comprises a plastic material.

14. The coupler of claim 10, wherein said means for stopping is a lens.

15. The coupler of claim 14, wherein the lens comprises a glass material.

16. The coupler of claim 14, wherein the lens comprises a plastic material.

17. The coupler of claim 14, wherein the lens is an aspherical lens.

18. The coupler of claim 14, wherein the lens is a spherical lens.

19. A method for coupling comprising:
receiving an optical fiber or coupling; and
restraining the receiving of the optical fiber with a mechanism having an index of refraction approximately equal to the index of refraction of the optical fiber.

20. The method of claim 19, wherein the mechanism is a window.

21. The method of claim 20, wherein the window comprises a glass material.

22. The method of claim 20, wherein the window comprises a plastic material.

23. The method of claim 19, wherein the mechanism is a lens.

24. The method of claim 23, wherein the lens comprises a glass material.

25. The method of claim 23, wherein the lens comprises a plastic material.

26. The method of claim 23, wherein the lens is an aspherical lens.

27. The method of clam 23, wherein the lens is a spherical lens.

28. The method of claim 23, wherein the lens has a flat surface facing the optical fiber that may be received.

29. The method of claim 23, wherein the lens has a curved surface facing the optical fiber that may be received.

30. A coupler comprising:
a sleeve;
a window situated at a first end of said sleeve; and
a lens situated at a surface of said window opposite of a surface of said window proximate to said sleeve.

31. The coupler of claim 30, wherein:
said sleeve has a diameter so that an optical fiber can be inserted with an end stopped by the surface of said window proximate to said sleeve; and
said window has an index of refraction about the same as the index of refraction of optical fiber.

32. The coupler of claim 31, wherein said lens is a ball lens.

33. The coupler of claim 31, wherein said lens is formed on the surface of said window.

34. The coupler of claim 33, further comprising a light source proximate to said lens.
